(19) United States
(12) Patent Application Publication
(10) Pub. No.: US 2005/0064178 A1
(43) Pub. Date: Mar. 24, 2005

(54) Cloth texture cover material

(76) Inventors: John D. Gray, Union, NH (US); Robert Booth, Venice, FL (US); Gerard L. Vachon, Rochester, NH (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/889,462

(22) Filed: Jul. 12, 2004

Related U.S. Application Data
(60) Provisional application No. 60/486,851, filed on Jul. 11, 2003.

(51) Int. Cl. B32B 5/16; B28B 1/52

(52) U.S. Cl. 428/327; 428/299.4; 428/308.4; 428/212; 264/54; 264/109; 264/220; 264/257; 264/331.11

(57) ABSTRACT

Plastic cover materials having the appearance and texture of cloth for upholstery and trim panel applications are formed by solidifying a composition onto a textured surface.

### CROSS REFERENCE TO RELATED APPLICATION

This application claims the benefit of U.S. Provisional Application No. 60/486,851, filed Jul. 11, 2003.

### FIELD OF THE INVENTION

This invention relates to cover materials for upholstery and trim panel applications, particularly for automotive applications and, more particularly, to forming a trim cover having the appearance and texture of a cloth or fabric by casting or spraying a polymer onto a textured surface.

### BACKGROUND OF THE INVENTION

Upholstery surfaces and adjacent panels in home and office environments as well as inside transportation vehicles are generally covered with a soft colored material to distinguish the surface from wood or metal and to provide a warm and pleasing appearance. These surfaces may comprise a trim cover which covers a foam pad to provide a comfortable interface with humans. The materials used to form these trim covers, often referred to as “interior trim” in the transportation industries, vary widely from plush leather, to plastic skins of vinyl, urethane, olefins and alloys thereof, to woven or knitted cloth, velour, suede or carpet and even hard plastic injection molded skins or shells. Recently, particularly in the automotive industry, there is increased interest in providing cloth surfaces for instrument panels, in addition to door panels and headliners, to provide differentiation of the vehicle interior as well as the potential for reduced cost. U.S. application Ser. No. 10/373,332, entitled “Preweakening of Fabric Covered Air Bag Doors” is directed at articles of this type and is commonly assigned to the assignee of the present invention and is included herein by reference. The use of a cloth or fabric to form complex shapes such as instrument panels may involve manufacturing the trim cover by any of a number of processes including but not limited to, vacuum forming, cut-and-sew and foaming-in-place. However, there are limitations as to the depth of draw, undercuts and return flanges that may be formed using these processes.

To allow the manufacture of trim covers for such complex shapes without the presence of unsightly parting lines on the outer surface, processes such as rotational casting, slush molding, blow molding and spraying have been used. In these instances, a mold surface is provided which is a mirror image replication of the desired surface of the final trim cover (e.g. leather, an embossed grain pattern, etc.). A liquid or molten flexible plastic is applied to the mold surface, and upon solidifying, a solid skin or shell useful as a trim cover is produced. Thermoset plastics or thermoplastic materials such as PVC, TPU, polyolefins and thermoplastic elastomers and alloys, blends and copolymers thereof, may be used to produce soft, flexible, plush feeling and aesthetically pleasing trim covers for a variety of products for a variety of industries.

To allow further differentiation of surfaces inside the home and office, and, particularly inside motor vehicles, there is a need to provide surfaces having the appearance and texture of a cloth or fabric but which may be produced by cast, spray, rotational, blow molding, injection molding or other plastic processes to produce trim covers of complex shapes without unsightly cut or joint lines.

It is thus an object of the present invention to provide trim covers for upholstery and similar applications having cloth-like texture and appearance which are produced by the solidification of a plastic material on a textured surface.

It is a further object of the present invention to provide trim covers having a cloth-like texture and appearance by casting plastic polymers on a textured surface.

It is a further object of the present invention to provide trim covers having a cloth-like texture and appearance by spraying plastic polymers on a textured surface.

It is a still further object of the present invention to provide a cloth-like appearance and texture to a cast or sprayed or molded plastic trim cover through the combination of one or more of the following:
the use of a mold surface which replicates a specific cloth or fabric pattern or texture (for instance; denim, suede, canvas, burlap, corduroy, linen, etc.),
the use of a mixture of particles of different and preferably contrasting colors to cast a skin wherein the particles melt individually but do not become a homogeneous mass, resulting in a variegated appearance,
the use of a mixture of particles of different polymer families, preferably incompatible or immiscible, such as vinyl and olefin, wherein the particles melt at different temperatures but do not become a homogeneous mass resulting in a skin with an uneven appearance.
the use of short fibers, preferably less than 0.040 inches in length, either natural, synthetic or a blend thereof, to form a skin having the fibers projecting from the outer surface
the use of a skin-forming material of reduced density having some open cells to allow the skin to be somewhat permeable to air flow.
the use of a finishing process such as needle punching or laser drilling to provide a breathable skin
embellishing the surface of the plastic skin with stitching, logos and indicia which coordinate with a specific theme for the surrounding in which the trim cover is used.

### SUMMARY OF THE INVENTION

In a first embodiment, the present invention is directed at providing a plastic cover material, preferably for a trim panel for the interior of an automotive vehicle, which has a cloth-like appearance and texture. The texture may be formed by applying a plastic material onto a textured surface or onto a replication of a textured surface.

In a second alternative embodiment, the present invention is directed at providing a plastic cover material, preferably for a trim panel for the interior of an automotive vehicle which has a cloth-like appearance and texture that is formed by spraying a plastic material onto a textured surface or onto a replication of a textured surface.

In a third alternative embodiment, the present invention is directed at providing a plastic cover material having a cloth-like appearance and texture which is formed by solidifying a plastic onto a surface which replicates a specific cloth or fabric texture. The solidification can take place by molding, such as injection molding.

In additional alternative embodiments, the present invention is directed at providing a cloth-like appearance and texture for a cast or sprayed or molded plastic cover by including one or more of the following in the composition of the plastic:
particles having different colors
particles from different polymer families which are preferably incompatible or immiscible
short natural or synthetic fibers or blends thereof
blowing agents

### BRIEF DESCRIPTION OF THE INVENTION

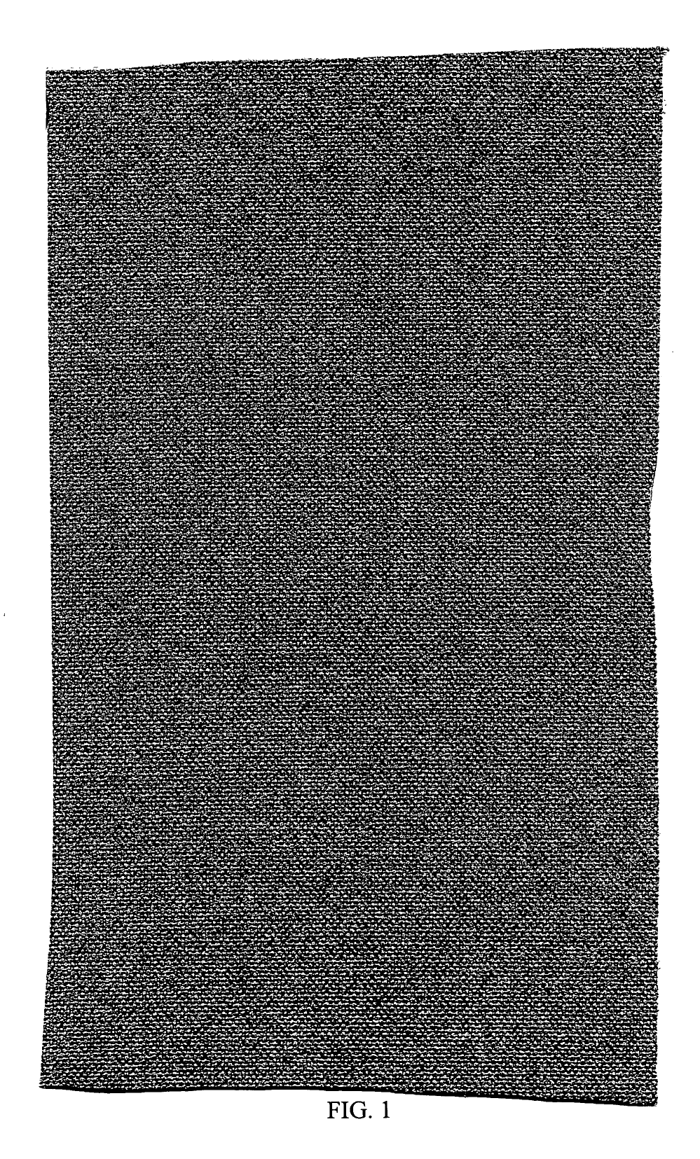

FIG. 1 is perspective view of a section of a trim cover of the present invention having a cloth-like appearance and texture.

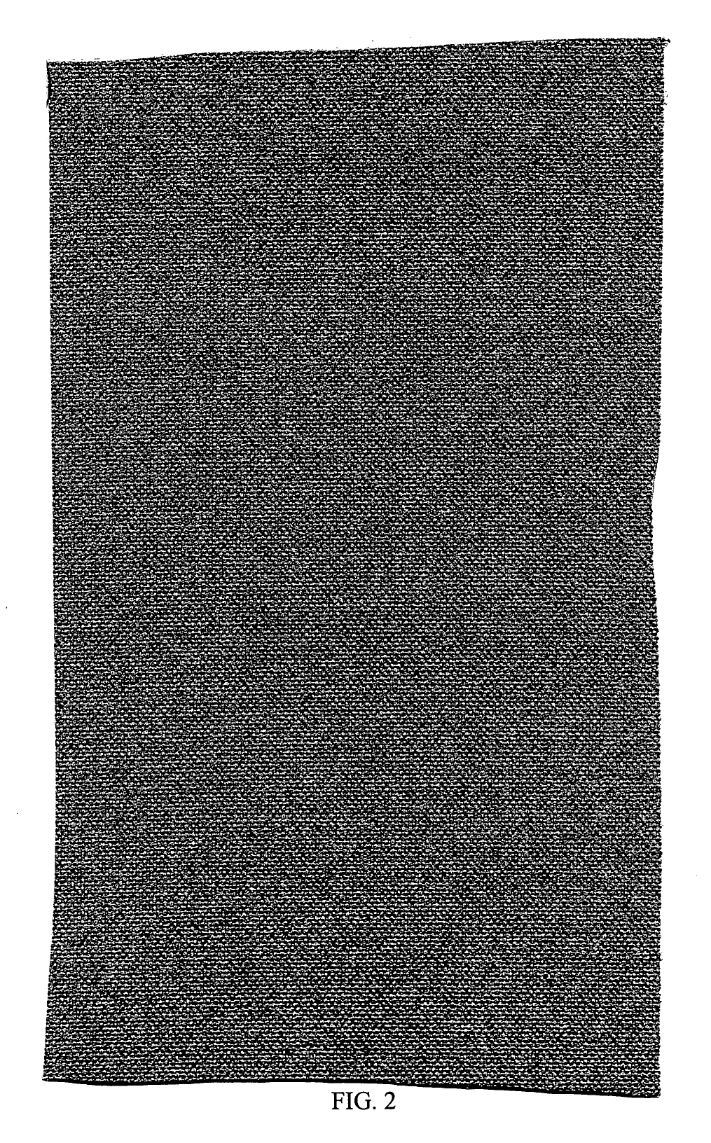

FIG. 2 is a perspective view of a section of a trim cover of the present invention having an alternative cloth-like appearance and texture.

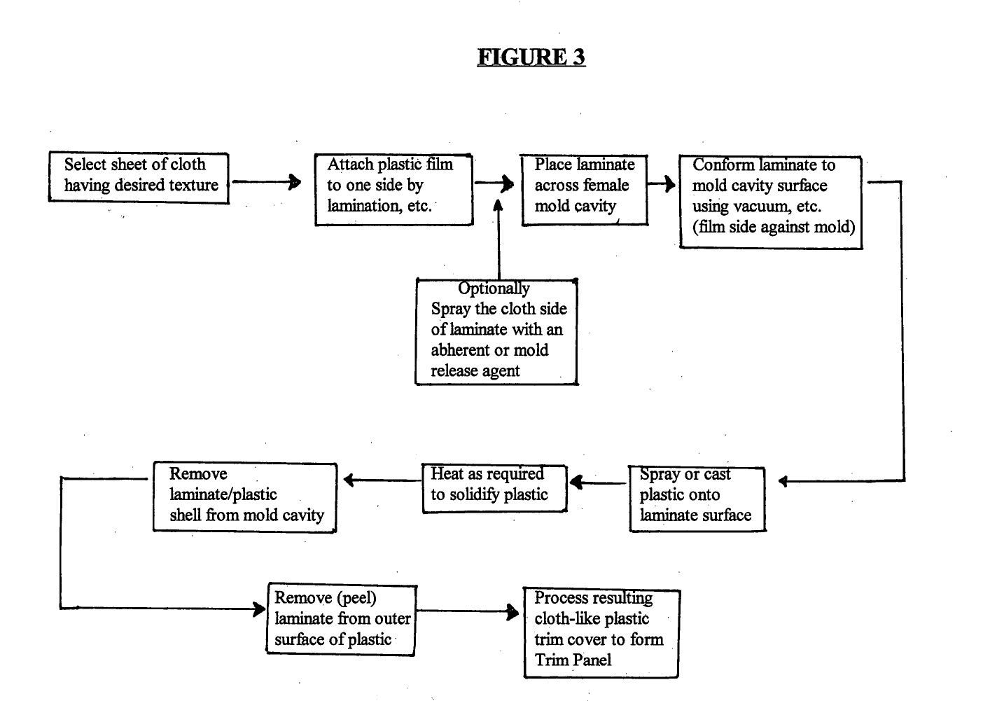

FIG. 3 is a schematic diagram of a novel process to form a mold surface for use with the present invention.

### DETAILED DESCRIPTION OF THE PREFERRED EMBODIMENTS

The present invention is preferably directed at providing cast or sprayed or molded plastic skins for use as trim covers for upholstery applications in the home, office or transportation industries, but particularly in the automotive industry, wherein the plastic skin has the appearance and texture of a cloth or fabric.

Cloth or fabric trim covers are known, however, their use in complex shapes such as instrument panels is limited somewhat by the pliability and extensibility of the cloth particularly if joint lines or cut seams are not desired. Accordingly, in the broad context of the present invention, a cloth surface is one which generally replicates a fibrous based material, i.e., a material that is composed primarily of fibers in any given fashion, including, but not limited to, denim, suede, canvas, burlap, corduroy, linen, any type of woven or non-woven fiber material, or tufted material, including carpeting, etc.

Plastic trim covers of PVC, TPU, TPO and the like can be produced by casting or spraying or molding a polymer onto a mold surface and solidifying the plastic. The resultant trim cover will display a mirror image of the surface of the mold.

It has been found that a plastic trim cover having the appearance and texture of a specific cloth or fabric can be produced by solidifying a polymer on a mold surface which has been carefully replicated from a sheet of that specific cloth or fabric. In a preferred embodiment, the mold surface comprises electroformed nickel and is constructed through a series of replications which ensure that the fidelity of the surface pattern of the desired surface (master) is transferred to the cast or sprayed trim cover. A sheet of cloth or fabric, or master, is applied to a male form having the desired shape of the final trim cover, preferably an automotive interior trim component and, more preferably, a portion of or an entire, instrument panel. Once the sheet has been adjusted to yield the desired appearance of the finished, cloth-like, trim cover, the covered form or mandrel proceeds through a series of surface replications, from male to female, as known to those skilled in the art, culminating in an electroformed nickel female mold. This mold which now possesses the mirror image of the texture of the original sheet of cloth, may be used to form a plastic trim cover by solidifying a plastic material on its surface. The plastic skin thus formed, when removed from the female mold, possesses the shape, appearance and texture of the original cloth-like trim cover, but has the physical properties of the plastic rather than the cloth.

Accordingly, in the context of the present invention, the term replication means that the cloth appearance and texture is one that is derived directly from a cloth material, which cloth material directly provides the necessary surface features to the mold surface, to provide the cloth appearance and texture upon subsequent molding. In such fashion, a molded product having more genuine cloth appearance and texture, is more efficiently realized.

Other mold surfaces than electroformed nickel may be used, including but not limited to, copper, nickel/copper or beryllium/nickel/copper electroforms, metal molds formed by vapor deposition, molds made of ceramic, EDM'd (electrical discharge machined) metal molds and molds made by rapid prototyping processes such as stereolithography (SLA), selective laser sintering (SLS), Laser Engineered Net Shaping (LENS), direct shell production casting, etc.

Mold surfaces of plastic may also be produced by injection molding and/or vacuum forming against a grained surface to provide a disposable grained mold (cavity) surface which may be cast or sprayed upon to form a trim cover (if the processing temperature of the cast or sprayed plastic is lower than the melting point of the mold material).

A particularly novel mold surface for the cloth-like trim cover of the present invention may be formed, as described in FIG. 3, by providing a sheet of cloth having the desired surface texture and appearance, and attaching to its front side a film to aid in forming the sheet to shape. The laminate of film and cloth is next suspended across a mold cavity of the desired shape and formed with the film side facing the mold surface, preferably by vacuum, to snugly fit within, and conform to, the shape of the mold cavity. Depending upon the composition of the cloth sheet and compatibility with the plastic which will form the trim cover, an optional step may be required to ensure that the cloth sheet and plastic do not adhere. If the cloth and plastic are different enough in composition, i.e., incompatible, this step may not be necessary. If required, this step may include the spraying of an adherent, or release agent, onto the surface of the cloth before the plastic is cast or sprayed onto the cloth surface. Subsequently, the mold cavity having a cloth texture outer surface is coated with plastic to form the skin or trim cover. While PVC, TPU, TPO and TPE's, and blends and alloys thereof may be cast as powders, it is preferable that a liquid, such as a thermosetting urethane formulation or plasticized PVC in the form of an organisol, is applied to the mold surface and, more preferably, a liquid which solidifies at or around room temperature, such as a thermosetting, or spray, urethane since the cloth material which comprises the mold surface may not be able to withstand the process temperatures required to melt the powder version of plastic used (300-500 degrees F.). The thermosetting spray urethane formulation preferably comprises polyol or polyamine precursors such as a polypropylene based triol, reacted with an aliphatic isocyanate such as isopherone diisocyanate. Once the sprayed urethane has been applied uniformly to the cloth-covered mold surface, preferably at 0.010 inches-0.050 inches in thickness, and cured, the skin or trim cover can be removed from the mold cavity while still in intimate contact with the cloth laminate that formed the mold surface. The plastic skin and cloth laminate may then be separated to yield the plastic skin having a cloth appearance and texture. A process for forming a skin of this type is disclosed in U.S. Pat. No. 5,512,233, commonly assigned to the assignee of the present invention and included herein by reference. Finally, the plastic skin may then be foamed in place, using means well known to those skilled in the art, to form a trim panel such as an instrument panel for a vehicle.

The process for forming trim covers, according to the present invention, will now be explained. Turning to FIG. 1, a section of a plastic trim cover is shown which has the appearance and texture of a canvas or coarsely woven surface. A sheet of cloth having the surface pattern as shown was used to form an electroformed nickel cavity, through the replication process described briefly above. The mold was used to form a section of a trim cover by heating the mold to about 100 degrees F.-150 degrees F. and spraying the surface with a thermosetting aliphatic urethane composition. The polyol side of the aliphatic urethane precursors was pigmented to a light beige color. The polyol side was mixed with an aliphatic isocyanate and sprayed on the mold surface to a thickness of about 0.020 inches-0.050 inches. The coating was then allowed to solidify. Upon stripping the resultant skin from the mold, a section of trim cover having the color, gloss, appearance and texture of the original canvas surface was obtained. A process for forming a skin of this type is disclosed in U.S. Pat. No. 5,512,233, commonly assigned to the assignee of the present invention and disclosed herein by reference.

FIG. 2 shows a section of a cloth-appearing trim cover made using a plasticized PVC drysol compound. In this example, a section of denim cloth was used as the master to provide the electroformed mold surface using the replication process described briefly above. The mold was installed in a hot air casting module and heated to about 450 degrees F. A drysol compound (plasticized PVC containing stabilizers, plasticizers, pigments, antioxidants, etc. of the type described in U.S. Pat. Nos. 5,998,030 and 5,564,102, both entitled “Material for Manufacturing Plastic Parts” and commonly assigned to the assignee of the present invention and included herein by reference) was cast onto the surface of the heated mold. The drysol compound comprised discrete resin particles tinted to white and blue colors which when blended together and cast on a surface yield the appearance of denim or “blue jeans”. U.S. Pat. No. 4,784,911, entitled “Three Dimensional Multi-Color Plastic Parts and Method of Making Same” commonly assigned to the assignee of the present invention and included herein by reference describes the use of these multi-colored particles. The blend of particles comprised microspheres or “mini-beads” in the size range of 0.007 to 0.040 inches [179 microns-1025 microns] as described in U.S. Pat. No. 6,410,141, entitled “Material and Process for Manufacturing Plastic Parts”, U.S. Pat. No. 5,525,284, entitled “Process for Manufacturing Plastic Parts” and U.S. Pat. No. 5,525,274, entitled “Process for Manufacturing Plastic Microspheres”, commonly assigned to the assignee of the present invention and included herein by reference. In addition, the particles may comprise particles that range in size between 0.0002 to 0.059 inches [5.0 microns-1500 microns].

In addition, the cloth textured cover material herein may be prepared via the process identified in U.S. patent application Ser. No. 10/433,361, and U.S. patent application Ser. No. 10/641,997 whose teachings are incorporated by reference. Specifically, the cover material can be prepared by preheating a metal mold having the cloth replication surface using infrared energy to establish a casting temperature, casting the plastic material onto said preheated mold surface and fusing said plastic into a substantially uniform layer using infrared energy and cooling said metal mold using evaporative cooling and removing the cover material from the mold. In addition, the cover material can be prepared by preheating a metal mold having a cloth textured mold contour using infrared energy from infrared heating elements that are formed to match said mold contour to establish a casting temperature, casting plastic material onto said preheated mold, fusing said plastic using infrared energy and cooling the metal mold by contacting the metal mold with a material which can change phase or state and removing the cast plastic article from said metal mold.

The drysol blend of microspheres was cast onto the hot mold surface and allowed to melt to a thickness of about 0.040 inches and the excess blend of microspheres dumped out of the mold. After fusing the molten layer, the mold was cooled to about 100 degrees F. and the cast section of plastic trim cover removed. As shown in FIG. 2, it possessed the color pattern, gloss, appearance and texture of the original sheet of denim.

In addition, aliphatic urethane elastomers as described in U.S. Pat. No. 6,187,859, entitled “Light Stable Aliphatic Thermoplastic Urethane Elastomer and Method of Making Same” and U.S. Pat. No. 5,824,738, which has the same title, may also be cast as powders, microspheres or mini-beads to form a trim cover of the present invention.

It should be apparent from the above written description and Figures that a trim cover having a texture and appearance closely resembling a specific cloth or fabric may be obtained by using a careful tooling replication process to maintain the texture of the original cloth master and by casting or spraying a plastic onto that tool surface. The appearance of the cast or sprayed trim cover may be further enhanced to replicate the original cloth wherein the sprayed or cast plastic includes one or more of the following:
a mixture of particles of contrasting colors;
a mixture of particles of plastic which are incompatible or immiscible with each other such as the use of two or more polymer materials with different melting points and/or solubility parameters;
short fibers which extend through the outer surface;
a reduced density to allow a low level of permeability;
a series of holes which allow air to pass through; and
decorative features such as logos, stitching, indicia, etc.

The description and drawings illustratively set forth the presently preferred invention embodiment. We intend the description and drawings to describe this embodiment and not to limit the scope of the invention. Obviously, it is possible to modify these embodiments while remaining within the scope of the following claims. Therefore, within the scope of the claims one may practice the invention otherwise than as the description and drawings specifically show and describe.

1. A cover material comprising an outer surface having a cloth appearance and texture formed by solidifying plastic particles in the size range of 5.0 microns to 1500 microns on a textured mold surface, wherein the mold surface is a replication of a cloth surface.

2. The cover material of claim 1 wherein said replication of a cloth surface comprises:
(i) covering a male form support with a cloth wherein said cloth has an exposed outer surface texture;
(ii) casting a resin transfer formulation onto said male form covered with said cloth wherein said resin transfer formulation upon hardening adopts said outer surface texture of said cloth onto a surface of the resin transfer formulation;
(iii) casting a mandrel onto said resin transfer formulation which contains said outer surface texture wherein said mandrel adopts said outer surface texture of said surface of said resin transfer formulation;
(iv) depositing metal onto said mandrel surface wherein said metal adopts said texture from said mandrel and forms a mold.

3. The cover material of claim 1, wherein the plastic particles are cast onto the mold surface and solidify by cooling.

4. The cover material of claim 1, wherein the plastic particles are cast onto the mold surface and solidify by fusing.

5. The cover material of claim 1, wherein the plastic particles are sprayed onto the mold surface.

6. The cover material of claim 1, wherein the plastic particles are melt flowed onto the mold surface.

7. The cover material of claim 1, wherein the plastic is comprised of one or a combination of any of the following: polyvinyl chloride, thermoplastic polyurethane, thermoset polyurethane, thermoplastic olefin, thermoplastic elastomer, thermoplastic rubber, styrene based polymers, and acrylic based polymers.

8. The cover material of claim 1, wherein the solidifying plastic particles contain blowing agents to lower its density and create a cellular structure.

9. The cover material of claim 1, wherein the solidifying plastic particles contain short glass fibers.

10. The cover material of claim 1, wherein the plastic particles are a mixture of particles pigmented in contrasting colors to provide a variegated effect.

11. The cover material of claim 1, wherein the trim cover is perforated to form holes.

12. The cover material of claim 11, wherein the holes are formed by needles.

13. The trim cover of claim 11, wherein the holes are formed by laser drilling.

14. The cover material of claim 1 wherein said plastic particles comprise two or more polymers which melt at different temperatures.

15. The cover material of claim 1 wherein said plastic particles comprise two or more polymers which have different solubility parameters.

16. A method for forming a cover material having a cloth-like appearance and texture comprising the steps of:
a. providing a mold for a cover material having a surface texture replicating a cloth texture;
b. applying plastic particles in the size range of 5.0 microns to 1500 microns to the mold surface to conform to and fill in the surface texture;
c. solidifying the plastic on the textured mold surface to form a plastic cover material;
d. separating the plastic cover material from the mold surface wherein said plastic cover material adopts the surface texture replicating a cloth texture.

17. A method for forming a cover material having a cloth-like appearance and texture comprising the steps of:
a. providing a sheet of cloth having a first surface, a second surface and a desired texture;
b. applying a formable film to the second surface of the sheet of cloth to form a laminate;
c. placing the laminate across a mold cavity with said formable film facing said mold cavity;
d. forming the laminate to conform to the mold cavity to cause the formable film contact the mold cavity surface;
e. applying a formulation capable of solidifying against the first surface of the cloth sheet;
f. solidifying the formulation into a cover material where said cover material adopts the texture of said cloth surface;
g. removing the cover material and laminate construction from the mold cavity;
h. separating the laminate from the cover material to yield a cloth-textured cover material.

18. The method of claim 17 wherein said formulation capable of solidifying comprises a thermoset composition.

19. The method of 17 wherein said formulation capable of solidifying comprises a thermoplastic composition.

20. The method of claim 17 wherein said formulation capable of solidifying comprises monomeric components which polymerize and solidify.

21. The method of claim 17 wherein said formulation capable of solidifying comprises reactants which react and solidify.

22. The method of claim 17, including the additional step of spraying an adherent onto the second surface of the sheet of cloth, wherein the additional step occurs prior to step (e).

23. The method of claim 22, wherein the adherent is a mold release.

24. A cover material for an article of furniture or a vehicle interior trim panel comprising an outer surface having a cloth appearance and texture formed by solidifying a composition on a textured mold surface, wherein the mold surface is a replication of a cloth surface.

25. The cover material of claim 24 wherein said replication of a cloth surface comprises:
(i) covering a male form support with a cloth wherein said cloth has an exposed outer surface texture;
(ii) casting a resin transfer formulation onto said male form covered with said cloth wherein said resin transfer formulation upon hardening adopts said outer surface texture of said cloth onto a surface of the resin transfer formulation;
(iii) casting a mandrel onto said resin transfer formulation which contains said outer surface texture wherein said mandrel adopts said outer surface texture of said surface of said resin transfer formulation;
(iv) depositing metal onto said mandrel surface wherein said metal adopts said texture from said mandrel and forms a mold.

26. The cover material of claim 24, wherein the liquid composition is cast onto the mold surface and solidifies by cooling.

27. The cover material of claim 24, wherein the liquid composition is cast onto the mold surface and solidifies by fusing.

28. The cover material of claim 24, wherein the liquid composition is sprayed onto the mold surface and solidifies by reacting.

29. The cover material of claim 24, wherein the liquid composition is sprayed onto the mold surface and solidifies by the evaporation of solvents.

30. The cover material of claim 24, wherein the liquid composition is comprised of one or a combination of any of the following: polyvinyl chloride, thermoplastic polyurethane, thermoset polyurethane, thermoplastic olefin, thermoplastic elastomer, thermoplastic rubber, styrene based polymer and acrylic based polymers.

31. The cover material of claim 24, wherein the liquid composition contains blowing agents to lower its density and create a cellular structure.

32. The cover material of claim 24, wherein the liquid composition contains short glass fibers.

33. The cover material of claim 24, wherein the trim cover is perforated to form holes.

34. The cover material of claim 33, wherein the holes are formed by needles.

35. The cover material of claim 33, wherein the holes are formed by laser drilling.

36. A method for forming a cover material having a cloth-like appearance and texture comprising the steps of:
a. providing a mold for a trim cover having a surface texture replicating a cloth texture;
b. applying a liquid composition to the mold surface to conform to and fill in the surface texture;
c. solidifying the liquid composition on the textured mold surface;
d. separating the plastic trim cover from the mold surface wherein said plastic cover material adopts the surface texture replicating a cloth texture.

37. The method of claim 36, wherein the step of applying said liquid composition to the mold surface comprises the casting of said liquid composition onto the textured mold surface.

38. The method of claim 37, wherein the liquid composition is a plasticized polyvinyl chloride composition.

39. The method of claim 36, wherein the step of applying said liquid composition to the mold surface comprises the spraying of a liquid onto the mold surface.

40. The method of claim 36, wherein the liquid composition is a thermosetting urethane compound.
